(19) United States
(12) Patent Application Publication
(10) Pub. No.: US 2012/0020861 A1
(43) Pub. Date: Jan. 26, 2012

(54) USE OF A TiO2- BASED COMPOSITION FOR CAPTURING HALOGENATED COMPOUNDS CONTAINED IN A GASEOUS MIXTURE

(76) Inventors: Marc-Antoine LELIAS, Ales (FR); Olivier Ducreux, Louveciennes (FR); David Chiche, Lyon (FR)

(21) Appl. No.: 13/248,785

(22) Filed: Sep. 29, 2011

Related U.S. Application Data
(63) Continuation of application No. 12/685,299, filed on Jan. 11, 2010, now abandoned.

(30) Foreign Application Priority Data
Jan. 12, 2009 (FR) 09/00.107

(51) Int. Cl. B01D 53/68; B01D 53/54

(52) U.S. Cl. 423/236; 423/240 S

(57) ABSTRACT

The invention is concerned with the use of a TiO₂-based composition for capturing halogenated compounds contained in a gaseous mixture, said composition comprising between 10 wt. % and 100 wt. % of TiO₂ and between 1 wt. % and 30 wt. % of at least one sulfate of an alkaline-earth metal selected from calcium, barium, strontium and magnesium.

The present invention is concerned with the purification of gaseous mixtures such as synthesis gases used in cogeneration units, Fischer-Tropsch synthesis processes, chemical synthesis processes, or fuel cells. The invention is concerned, more particularly, with the use of a TiO₂-based composition as the capture mass for eliminating halogenated impurities such as HF, HCl, HBr, and/or HI.

### PRIOR ART

Conventionally, synthesis gas can be obtained by converting natural gas, carbon, heavy petroleum residues or biomass by way of processes such as steam reforming, autothermal reforming, or partial oxidation, or by the decomposition of methanol.

Usually, the mixture comprises carbon monoxide, hydrogen, water vapour and carbon dioxide, in amounts which vary depending upon the production process used for the synthesis gas. As a function of the type of charge from which it is obtained, the synthesis gas also contains impurities such as sulfur-containing compounds, nitrogenous compounds, halogenated compounds and/or metals.

In particular, significant amounts of halogenated compounds are found, such as HF, HCl, HBr and/or HI in the synthesis gas resulting from gasification of the biomass, carbon, petroleum residues, alone or mixed (so-called “co-processing”).

The halogenated compounds initially present in the charge to be gasified can amount to 1000 ppm by wt. in the case of carbon, and even 10000 ppm by wt. in the case of the biomass, depending on its type and geographical origin. These compounds which are present in the charge are still to be found in the gas following conversion.

The halogenated compounds present in the unpurified synthesis gases can cause accelerated corrosion of the installations in which they are used, such as, for example, of the gas turbines in the “Integrated Gasification Combined Cycle” (IGCC). Cogeneration permits the production of electricity and thermal energy which can be used in the form of water vapour or combustion gas from a fuel, such as natural gas, biomass, carbon. The gases from a cogeneration installation have to comply with very specific standards associated with the requirements of the processes downstream. Halogenated compounds are thus frequently encountered, and they have to be eliminated effectively.

Halogenated impurities are also capable of poisoning the catalysts which are used in Fischer-Tropsch processes or in chemical synthesis processes such as methanol synthesis processes, or they are capable of weakening the performances of the materials used in fuel cells.

For these reasons, the requirements in respect of gas purity are very strict. Therefore, the halogenated impurities need to be eliminated, as well as the other types of impurity which also need to be eliminated, so that the gas will contain no more than residual contents of them, those residual contents in general preferably being less than 10 ppb by wt. for each constituent.

The purification can be effected by processes which use solvents or capture masses.

The technique of washing with solvent generally requires the use of a basic solvent in order to draw off the halogenated, acid compounds from the gas to be treated. To that end, several types of solvent can be used. Solvents containing amines, such as monoethanolamine (MEA), diethanol amine (DEA) or methyldiethanolamine (MDEA), used conventionally for the elimination of acid gases like H₂S or CO₂, can also be used to eliminate halogenated compounds, in which case the compounds to be eliminated react chemically with the solvent. If DEA is used, it is also possible to eliminate the COS to 50% in the case of extreme elimination, a step for the hydrolysis of the COS into H₂S being necessary upstream of the absorption column. HCN is also eliminated, but to the detriment of the solvent which undergoes irreversible deterioration. Water, possibly in the presence of sodium, can also be used in order to eliminate halogenated impurities.

The Rectisol® process can also be used to eliminate acid gases. Purification is realised by carrying out extraction with methanol at very low temperatures (−40 to −60° C.). This process also permits the elimination of other impurities, such as sulfur-containing compounds, and also nitrogenous compounds (NH₃, HCN), and heavy metals such as arsenic and mercury.

Processes which employ physical solvents, such as solvents based on polyethylene glycol diallyl-ether mixes, can also be used, or those employing mixed physical and chemical solvents, such as mixtures of amines and sulfolane.

These washing processes are usually carried out at temperatures of between −80° C. and 250° C., depending upon the type of solvent used.

Processes which employ capture masses are more capable of purifying hot gases. In this case, the gas treatment does not necessarily require the temperature of the gas to be reduced, and it is therefore more economical in terms of energy. Conventionally, capture masses such as solids based on dolomite, zeolites, basic aluminas or aluminas treated with alkaline metals, or zinc oxides, can be used.

The use of treated aluminas is the most usual for purifying gases at high temperature.

By way of example, U.S. Pat. No. 6,200,544 describes an adsorbent which permits the elimination of HCl from gases, the adsorbent comprising an activated alumina which is impregnated with an alkaline oxide and doped with phosphates and/or organic amines.

WO 1999/40999 describes a process which employs an adsorbent for eliminating halogenated compounds, such as hydrogen chloride (HCl), which are present in gaseous or liquid charges, the adsorbent being obtained by deposition on an alumina of at least one element selected from alkalis, or from alkaline-earths and rare earths. The adsorbent is prepared by calcining at a temperature of at least 500° C. or 600° C. depending upon the type of doping agent.

EP 0 948 995 is concerned with a process permitting the elimination of halogenated compounds present in gaseous or liquid phase, which is carried out by using an adsorbent constituted by an alumina and at least one element selected from metals from groups VIII, IB and IIB of the Periodic Classification of Elements, the content of metal element being, at most, 45 wt. % in relation to the total weight of the composition.

The problems associated with using basic aluminas or aluminas which have been treated with alkaline metals are generally concerned with their insufficient chlorine capture capacity (most frequently of about 8 wt. %), or with the temperature at which they are used, which is very often limited to 150° C., which involves cooling the gas prior to treatment.

The Applicant has discovered that by using one particular capture mass which is based on TiO₂ and which comprises at least 1 wt. % of at least one sulfate of an alkaline-earth metal selected from calcium, barium and magnesium, it is possible to eliminate halogenated impurities such as HF, HCl, HBr, and/or HI with a very good capturing efficiency. In fact, it has been found that by using the composition according to the invention, a gaseous mixture which initially contains in general from 0.1 to 1000 ppm by wt., preferably between 10 and 10000 ppm by wt., of these impurities can be purified so as to only then contain less than 10 ppb wt., or even less than 5 ppb wt., of halogenated impurities.

Use of the particular composition such as described in the present invention can advantageously take place at temperatures which can reach to 350° C., and therefore there is little or no need to lower the temperature of the gas from a synthesis gas production unit prior to purification.

Furthermore, another advantage lies in the catalytic properties of the capture mass used, particularly in respect of the COS and HCN hydrolysis properties described in FR 2 830 466 by the Applicant. The capture of halogenated compounds does not bring about deactivation of the mass, and this latter has good stability vis-à-vis COS and HCN hydrolysis reactions in the presence of these compounds.

Another advantage is in respect of the use of the invention for the purification of synthesis gases used in Fischer-Tropsch units, since the conditions for using those units and the process or use according to the invention are very similar.

This solid can also be used for the purification of the synthesis gas which can be used in cogeneration installations, chemical synthesis processes such as methanol synthesis processes, or fuel cells.

### SUMMARY OF THE INVENTION

The invention is concerned with a TiO₂-based composition for capturing halogenated compounds contained in a gaseous mixture, said composition comprising between 10 wt. % and 100 wt. % of TiO₂ and between 1 wt. % and 30 wt. % of at least one sulfate of an alkaline-earth metal selected from calcium, barium, strontium and magnesium.

The invention is therefore concerned with a process for the purification of a gaseous mixture which employs said composition and which permits elimination of said halogenated impurities. Furthermore, said process simultaneously permits hydrolysis of COS and HCN.

### DETAILED DESCRIPTION

The invention relates to the use of a TiO₂-based composition (also called capture mass) for eliminating (capturing) halogenated impurities such as, for example, HF, HCl, HBr and/or HI contained in a gaseous mixture, such as, preferably, a synthesis gas, or any other gas which can contain halogenated compounds, such as the hydrogen used in refineries, or synthetic natural gases.

The invention is therefore concerned with a process for the purification of a gaseous mixture which employs said composition and which permits the elimination of said halogenated impurities.

When the gaseous mixture is a synthesis gas it can advantageously be obtained by converting the biomass on its own or with carbon, natural gas or petroleum residues as supplements, using processes such as partial oxidation or steam reforming, or any other process known to the person skilled in the art. It comprises at least hydrogen and carbon monoxide.

When the gaseous mixture is a synthesis gas used in Fischer-Tropsch synthesis, it most frequently has an H₂/CO molar ratio of between 0.5 and 5.0, preferably of between 1.2 and 3.1, and still more preferably of between 1.5 and 2.6. The synthesis gas generally further comprises a small amount of carbon dioxide (CO₂), preferably less than 15% by volume, or even, less than 10% by volume, and possibly water vapour.

When the gaseous mixture is a cogeneration gas it most frequently has concentrations by volume of between 10 and 40% by volume for hydrogen, of between 15 and 70% by volume for carbon monoxide (CO), between 200 ppm and 5% by volume for hydrogen sulfide (H₂S), between 0.5 and 25% by volume for H₂O, and, possibly, carbon dioxide.

In general, a synthesis gas also comprises a number of impurities such as sulfur-containing impurities (H₂S, COS, CS₂), nitrogenous impurities (NH₃, HCN), halogenated impurities (HF, HCl, HBr, HI), and also metals, such as mercury, selenium and metal carbonyls.

The content of these impurities which are present in the gas resulting from gasification depends on the type of charge used. More particularly, the content of halogenated compounds can be between about 10 and 1500 ppm by wt., or even between 50 and 1000 ppm by wt. The content of sulfur-containing compounds can be of the order of 20 to 15000 ppm by wt., or even of the order of 100 to 10000 ppm by wt.

The crude synthesis gas which results directly from gasification and which may have been subjected to a step in which the carbon monoxide was converted into water vapour (so-called “gas shift”) in order to adjust the H₂/CO ratio is generally sent to one or more purification steps responsible for eliminating the metals present as well as most of the sulfur-containing compounds, nitrogenous compounds and halogenated compounds. The step(s) is/are generally carried out by washing with a solvent.

The washing with a solvent is generally carried out using a solvent which contains at least one amine, such as monoethanolamine (MEA), diethanolamine (DEA) or methyldiethanolamine (MDEA), or a solvent containing at least one alcohol such as methanol. Solvents based on mixtures of polyethylene glycol (PEG) dialkyl-ether, such as PEG diethyl ether or PEG dibutyl ether can also be used, or mixed physical and chemical solvents, such as those obtained from mixtures of an amine, such as MDEA or diisopropanolamine (DIPA), with sulfolane and water.

Following this treatment, the impurities content in the synthesis gas generally reach 0.1 to 50 ppm by wt. for halogenated compounds, from 0.1 to 50 ppm by wt. for H₂S, from 0.1 to 50 ppm by wt. for COS, and from 0.1 to 50 ppm by wt. for nitrogenous compounds.

The halogenated compounds present in the synthesis gas can be eliminated upstream or downstream from the previous purification step, or any other purification step which may possibly be used.

According to the invention, the halogenated compounds are eliminated by using a TiO₂-based composition as the mass for capturing the halogenated compounds, said composition comprising between 10 wt. % and 100 wt. % of TiO₂ and between 1 wt. % and 30 wt. % of at least one sulfate of an alkaline-earth metal selected from calcium, barium, strontium and magnesium. Said sulfate is preferably calcium sulfate.

According to one preferred embodiment, the composition comprises between 30 wt. % and 99 wt. % of TiO₂, more preferably between 45 wt. % and 98 wt. %, very preferably between 60 wt. % and 95 wt. %, or, even, between 70 wt. % and 90 wt. %.

Preferably, said composition comprises between 3 wt. % and 25 wt. %, and, more preferably, between 5 wt. % and 15 wt. %, of a sulfate of an alkaline-earth metal selected from calcium, barium, strontium and magnesium. Said sulfate is preferably calcium sulfate.

Preferably, the composition also comprises at least one compound selected from clays, silicates, aluminas, titanium sulfate, ceramic fibres, preferably clays or silicates, possibly aluminas, very preferably clays, with a total content of between 0.1 wt. % and 30 wt. %, preferably of between 0.5 wt. % and 25 wt. %, more preferably of between 1 wt. % and 20 wt. %, and very preferably of between 5 wt. % and 15 wt. %.

Preferably, the composition further comprises between 0.1 and 20 wt. %, preferably between 0.5 wt. % and 15 wt. %, and more preferably between 1 wt. % and 10 wt. %, of a doping compound or a combination of doping compounds selected from compounds of iron, vanadium, cobalt, nickel, copper, molybdenum and tungsten. The doping compound(s) is/are preferably in the form of oxides or sulfides. Preferably, said doping compound is iron, vanadium, nickel or molybdenum, very preferably iron or vanadium.

In one particularly advantageous embodiment, the composition comprises:
between 60 wt. % and 95 wt. %, or even between 70 wt. % and 90 wt. %, of titanium oxide,
between 3 wt. % and 25 wt. %, or even between 5 wt. % and 15 wt. %, of sulfate of an alkaline-earth metal selected from calcium, barium, strontium and magnesium,
between 0.1 wt. % and 20 wt. %, or even between 1 and 10 wt. %, of a doping compound or a combination of doping compounds selected from compounds of iron, vanadium, cobalt, nickel, copper, molybdenum and tungsten, for example in oxide or sulfide form.

The composition according to the invention can be prepared using any method known to the person skilled in the art. Doping agent(s) can be added during formation of the titanium oxide and alkaline earth sulfate, or subsequent to that operation. If the latter is done, dry impregnation of one or several metallic salt solutions is preferred, the preparation being done conventionally by means of a heat treatment.

The capture composition or mass can be in any known form: powder, balls, extrudates, monoliths, crushed material, etc. The preferred form is an extrudate, whether cylindrical or polylobe. If shaping is performed by mixing followed by extrusion, the cross-section of the extrudate is advantageously between 0.5 and 8 mm, preferably between 0.8 and 5 mm.

According to the invention, the capture mass is used either in a fixed bed reactor, or in a radial reactor, or in a fluidised bed with or without the use of a distributor plate.

The operating conditions are such that the pressure is between 0.5 and 10 MPa, preferably between 1.5 and 3.5 MPa, and, still more preferably, between 2.0 and 3.0 MPa, the temperature being between 100 and 350° C., preferably between 100 and 250° C.

Following the elimination of the halogenated compounds, the purified gas has a residual content of halogenated compounds which is less than 10 ppb by wt., or even 5 ppb by wt. for each constituent.

Furthermore, the capturing of the halogenated compounds has no impact on the catalytic is properties of the composition vis-à-vis COS and HCN hydrolysis reactions, since the solid retains its initial activity.

This mass can be used in the purification of gases used in cogeneration installations. In cogeneration installations, the synthesis gases are generally used at a pressure of between 1 and 10 MPa, and at a temperature of between 100 and 280° C.

The solid can also be used for the purpose of eliminating the halogenated compounds present in gases used in chemical synthesis units, such as methanol synthesis units. In the most recent processes, the synthesis of methanol is generally carried out at a pressure of between 1 and 15 MPa, preferably of between 5 and 10 MPa, and at a temperature of between 150 and 300° C., preferably of between 220 and 280° C.

Advantageously, the capture mass is used upstream from a Fischer-Tropsch synthesis unit which is usually used at a pressure of between 0.1 and 15 MPa, preferably of between 1.5 and 5 MPa, and at a temperature of between 150 and 400° C., preferably of between 170 and 350° C.

The Fischer-Tropsch synthesis unit operates either in fluidised bed or in fixed bed (a reactor containing a fixed bed catalyst or a plurality of catalyst beds in one and the same reactor), or in a triphase (“slurry”) reactor which comprises the catalyst in suspension in a substantially inert liquid phase and the reactive gaseous phase (synthesis gas).

The catalyst which is used for the Fischer-Tropsch synthesis procedure is generally a catalyst containing cobalt or iron with or without a support, the support preferably being selected from oxides from the group formed of alumina, silica, zirconia, titanium oxide, magnesium oxide, or mixtures thereof.

The use of a capture mass for eliminating halogenated compounds in a synthesis gas is more particularly appropriate when the catalyst used for the Fischer-Tropsch synthesis procedure comprises cobalt, possibly with an alumina support, for example.

Generally speaking, the invention is concerned with the use of said composition both as a capture mass for eliminating halogenated impurities, such as HF, HCl, HBr or HI, contained in a gaseous mixture, and as a catalyst for carrying out hydrolysis of COS and/or HCN.

### Example

### Example 1

### According to the Invention

A composition comprising 85.5 wt. % of TiO₂, 0.5 wt. % of Al₂O₃, 10 wt. % of CaSO₄. This latter is in the form of extrudates of diameter 2 mm. The composition is used in a fixed bed reactor for the purpose of purifying a synthesis gas containing approximately 61 volume % of CO, 19 volume % of H₂, 10 volume % of N₂ and 10 volume % of CO₂ as majority compounds, as well as impurities with contents of 5 ppm by wt. of HCl, 0.8 ppm by wt. of HF, 4 ppm by wt. of HBr, 1.5 ppm by wt. of HI, 10000 ppm by wt. of H₂S, 1200 ppm by wt. of COS, 100 ppm by wt. of HCN, and 3 ppm by wt. of NH₃.

The operating conditions are as follows:
Temperature: 180° C.
Pressure: 2.3 MPa
Hourly space velocity (HSV): 2500 h⁻¹.

The composition of the gas before and after purification is shown in Table 1.

TABLE 1

| Impurities | Content (ppm by wt.) | Content (ppb wt.) |
|---|---|---|
| present in the gas | before purification | after purification |
| H₂S | 10000 | Not analysed |
| NH₃ | 3 | Not analysed |
| COS | 1200 | <5 |
| HCN | 100 | <5 |
| HCl | 5 | <5 |
| HF | 0.8 | <5 |
| HBr | 4 | <5 |
| HI | 1.5 | <5 |

The results of Table 1 show that the halogenated compounds initially present were completely eliminated from the treated gas. Furthermore, use of the composition also made possible the hydrolysis of both the COS and HCN impurities. Capturing the halogenated compounds did not therefore have the effect of rendering the solid inactive vis-à-vis catalysis in the COS and HCN hydrolysis reactions.

Moreover, the capture mass used was analysed by means of a semi-quantitative dosing technique based on X-ray fluorescent analysis. The composition of the mass before and after use is given in Table 2. It is clearly noted that the halogenated impurities initially present in the gas for treatment were trapped on the solid.

TABLE 2

| Halogenated | Content (wt. %) | Content (wt. %) |
|---|---|---|
| Impurities | before use | after use |
| Fluorine | Not detected | 0.05 |
| Chlorine | Not detected | 0.3 |
| Iodine | Not detected | 0.1 |
| Bromine | Not detected | 0.24 |

### Example 2

### According to the Invention

A composition comprising 85.5 wt. % of TiO₂, 0.5 wt. % of Al₂O₃, 10 wt. % of CaSO₄. This latter is in the form of extrudates of diameter 2 mm. The composition is used in a fixed bed reactor for the purpose of purifying a synthesis gas containing approximately 36 volume % of CO, 24 volume % of H₂, 20 volume % of H₂O and 18.5 volume % of CO₂ as majority compounds, and also impurities with contents of 25 ppm by wt. of HCl, 1.5 ppm by wt. of HBr, 10000 ppm by wt. of H₂S, 800 ppm by wt. of COS, 640 ppm by wt. of HCN, and 2000 ppm by wt. of NH₃.

The operating conditions are as follows:
Temperature: 190° C.
Pressure: 2.5 MPa
Hourly space velocity (HSV): 4000 h⁻¹.

The composition of the gas before and after purification is given in Table 3.

TABLE 3

| Impurities | Content (ppm by wt.) | Content (ppb by wt.) |
|---|---|---|
| present in the gas | before purification | after purification |
| H₂S | 10000 | Not analysed |
| NH₃ | 2000 | Not analysed |
| COS | 800 | <5 |
| HCN | 640 | <5 |
| HCl | 25 | <5 |
| HBr | 1.6 | <5 |

The results of Table 3 show that the halogenated compounds initially present were completely eliminated. Use of the composition also made it possible to eliminate both the COS and HCN. The solid was not rendered inactive vis-à-vis its catalysis properties in the COS and HCN hydrolysis reactions.

Moreover, the capture mass used was analysed by means of a semi-quantitative dosing technique based on X-ray fluorescent analysis. The composition of the mass before and after use is given in Table 4. It is clearly noted that the halogenated impurities initially present in the gas for treatment were trapped on the solid.

| Halogenated | Content (% by wt.) | Content (% by wt.) |
|---|---|---|
| Impurities | before use | after use |
| Chlorine | Not detected | 0.18 |
| Bromine | Not detected | 0.012 |

Without further elaboration, it is believed that one skilled in the art can, using the preceding description, utilize the present invention to its fullest extent. The preceding preferred specific embodiments are, therefore, to be construed as merely illustrative, and not imitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding FR application Ser. No. 09/00.107, filed Jan. 12, 2009, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A method for eliminating halogenated impurities including at least one of HF, HCl, HBr and/or HI contained in a gaseous mixture, hydrolysis of COS and/or of HCN, comprising contacting effluent from a Fischer-Tropsch synthesis unit with a captive mass composition comprising between 30 wt. % and 99 wt. % of TiO₂ and between 1 wt. % and 30 wt. % of at least one sulfate of an alkaline-earth metal selected from calcium, barium, strontium and magnesium.

2. The method according to claim 1, wherein said composition comprises between 3 wt. % and 25 wt. % of at least one sulfate of an alkaline-earth metal selected from calcium, barium, strontium and magnesium.

3. The method according to claim 1, wherein said sulfate is calcium sulfate.

4. The method according to claim 3, wherein said composition comprises between 60 wt. % and 95 wt. % of TiO₂.

5. The method according to claim 1, wherein said composition further comprises at least one compound selected from clays, silicates, aluminas, titanium sulfate, and ceramic fibres with a total content of between 0.1 wt. % and 30 wt. %.

6. The method according to claim 1, wherein said composition further comprises between 0.1 wt. % and 20 wt. % of a doping compound, or a combination of doping compounds selected from compounds of iron, vanadium, cobalt, nickel, copper, molybdenum and tungsten.

7. The method according to claim 6, wherein the doping compound(s) are in the form of oxides or sulfides.

8. The method according to claim 1, wherein the capture composition or mass is shaped by extrusion.

9. The method according to claim 1, wherein the gaseous mixture is a synthesis gas containing, prior to contact with the composition, a content of halogenated compounds of between 0.1 ppm by wt. and 1000 ppm by wt.
